(19) United States
(12) Patent Application Publication
(10) Pub. No.: US 2014/0302298 A1
(43) Pub. Date: Oct. 9, 2014

(54) MINERAL-CONTAINING FILMS

(71) Applicants: Harry B. Wilfong, HARTSVILLE, SC (US); PATRICK J. HOVER, FAIRVIEW, TX (US); Danny G. Hillard, FLOWER MOUND, TX (US); TODD SHAW, RICHMOND, RI (US)

(72) Inventors: Harry B. Wilfong, HARTSVILLE, SC (US); PATRICK J. HOVER, FAIRVIEW, TX (US); Danny G. Hillard, FLOWER MOUND, TX (US); TODD SHAW, RICHMOND, RI (US)

(73) Assignee: HILEX POLY CO. LLC, Hartsville, SC (US)

(21) Appl. No.: 14/213,477

(22) Filed: Mar. 14, 2014

Related U.S. Application Data
(60) Provisional application No. 61/800,916, filed on Mar. 15, 2013.

(51) Int. Cl. C08K 3/26; B32B 27/20

(52) U.S. Cl. CPC C08K 3/26; B32B 27/20; C08K 2003/265; B32B 2439/70
USPC 428/220; 524/427; 428/516

(57) ABSTRACT

Films containing one or more inorganic filler materials are disclosed. Such films may have a single layer and may be multilayered, and one or more layers of such multilayered films may contain one or more inorganic filler materials. In some embodiments, the inorganic filler material may include calcium carbonate.

### CROSS-REFERENCE TO RELATED APPLICATION

This application is a non-provisional application of U.S. Provisional Application No. 61/800,916, filed Mar. 15, 2013, which is hereby incorporated by reference in its entirety.

### BACKGROUND

Various film products are known and useful for many applications, including for packaging of food products and other items.

### SUMMARY OF THE INVENTION

The present invention is for film products as more fully set forth herein.

In one embodiment, a film is set forth that has at least one film layer that comprises by weight at least about 40% inorganic filler material and at least about 10% high density polyethylene, including any high density polyethylene carrier in the inorganic filler material. In certain embodiments, the film layer comprises, by weight, at least about 40% calcium carbonate and at least about 10% high density polyethylene, including any high density polyethylene carrier in the calcium carbonate and wherein the film has been stretched in the machine direction.

The present invention may be better understood by reference to the description and figures that follow. It is to be understood that the invention is not limited in its application to the specific details as set forth in the following description and figures. The invention is capable of other embodiments and of being practiced or carried out in various ways.

### BRIEF DESCRIPTION OF THE DRAWINGS

These and other features, aspects, and advantages of the present invention are better understood when the following Detailed Description is read with reference to the accompanying drawing, wherein:

FIG. 1 depicts an exemplary embodiment of a multilayer film of the present invention.

### DETAILED DESCRIPTION OF EXEMPLARY EMBODIMENTS

In some embodiments, a film of the present invention may include at least one film layer having an inorganic filler material. As used herein, the terms inorganic filler material and mineral are used interchangeably. By way of example, in some embodiments, inorganic filler materials in films of the present invention may include calcium carbonate, talc, zinc oxide, titanium oxide, clay, diatomaceous earth, and combinations thereof. In some embodiments, the inorganic filler material may include calcium carbonate. In some embodiments, such inorganic filler materials may cause cavitation or microvoids in the film. Without intending to be bound by theory, it is believed that such cavitation or microvoids may result from air entrapped within a film surrounding the inorganic filler material. As a result, some embodiments of such films may have a lower density and increased yield as compared with similar polyolefin films that lack inorganic filler materials.

In some embodiments, at least one film layer may be composed of at least about 30%, 35%, 40%, 45%, 50%, 55%, 60%, 65%, 70%, or 75% inorganic filler material, including each intermittent value in the foregoing range, in some embodiments, a film may be composed of at least 50% inorganic filler material. Other components of such a film layer may include any suitable polyolfin, including, without limitation, high density polyethylene, high molecular weight high density polyethylene (HMW-HDPE), low density polyethylene, linear low density polyethylene, polypropylene, metalized biaxially-oriented polypropylene. In one embodiment, a mineral-containing layer may include high density polyethylene, either alone or in combination with other poleolefins. In some embodiments, the high density polyethylene may be high molecular weight high density polyethylene. As used herein to reference film composition percentages, reference to a film indicates a film layer, recognizing that optional additional layers present in a final multilayer film product are not accounted for in such values.

By way of example, the present invention includes a film having by weight about (or alternatively at least about) 40 to 65% calcium carbonate, about (or alternatively at least about) 20 to 40% high density polyethylene, and optionally about (or alternatively at least about) 5 to 15% of either low density polyethylene or any additional polyethylene having a melt index of about 1.8 to 3.0 g/10 mins. In one embodiment, the film may have a calcium content of about 56% by weight, whereas in other embodiments the film may have a calcium carbonate content of about 40, 45, 50, 55, 60, or 65%. In still other embodiments, the present invention includes a film having a calcium carbonate content of at least 40%. In yet other embodiments, the present invention includes a film having a calcium carbonate content of at least 50%. In some embodiments, the film may have a high density polyethylene content by weight of about 20, 25, 30, 35, 40, 45, or 50%, and some embodiments of the film may include by weight 5, 10, or 15% low density polyethylene or another polyethylene having a melt index of about 1.8 to 3.0 g/10 mins. Any combination of the materials in the foregoing ranges is encompassed within the scope of the present invention, and in some embodiments no other components are present in the film except for high density polyethylene, low density polyethylene, and calcium carbonate. In some embodiments, a calcium masterbatch may be used in forming a film or film layer, wherein a calcium masterbatch may include both calcium carbonate and a suitable carrier, such as high density polyethylene. By way of example, a calcium masterbatch having 70% calcium carbonate and 30% high density polyethylene, such as a calcium carbonate in pellet form (having 70% calcium powder and 30% high density carrier resin by weight) available as T986B1 from Heritage Plastics in Picayune, Miss., may be employed for some embodiments of the present invention. In some embodiments, about 50% to about 80% calcium masterbatch may be used in forming a film or film layer.

By way of further illustration, one embodiment of the present invention includes a film may comprise about 56% calcium carbonate, about 34% high density polyethylene, and about 10% low density polyethylene or another polyethylene having a melt index of about 1.8 to 3.0 g/10 mins. In another embodiment, a film of the present invention may contain by weight 50.4% calcium and 49.6% high density polyethylene. In still a further exemplary embodiment, a film of the present invention may contain calcium carbonate and high density polyethylene, wherein calcium carbonate accounts for at least about 40% of the film by weight. In yet another exemplary embodiment, a film of the present invention may contain calcium carbonate and high density polyethylene, wherein calcium carbonate accounts for at least about 50% of the film by weight. In some embodiments, a film or film layer of the present invention may consist essentially of inorganic filler materials, such as calcium carbonate, and high density polyethylene. Any of the foregoing references to high density polyethylene may alternative include high molecular weight high density polyethylene.

Films of the current invention can have varying thicknesses or gauges. In some exemplary embodiments, a film of the present invention may be 0.5, 0.75, 1.0, 1.25, 1.5, 1.75, 2.0, 2.25, or 2.5 mils. In some embodiments, films of the present invention may have a thickness of at least 0.75 mil. In some films, it may also be desirable to have a relatively consistent film thickness. Some embodiments of the present invention include films having a thickness that is generally consistent. By way of example, the gauge variation of some films of the present invention may be less than 20%. In other embodiments, the gauge variation may be less than 10%. In still other embodiments, the gauge variation may be less than 5%. In yet other embodiments, the gauge variation may be less than 2%.

In some embodiments of the present invention, films of the present invention may be oriented, or stretched, in the machine direction only (“MDO”), such as after an extrusion process. The MDO draw-stretch ratio for a film may vary depending upon the components of the film and the properties desired. In some embodiments, the draw-stretch ratio may be in the range of about 1:1 up to about 8:1, including each intermittent value therebetween. In other embodiments, an MDO draw-stretch ratio of about 1.1:1 to about 3:1 may be utilized, including each intermittent value therebetween. In still other embodiments, an MDO draw-stretch ratio of about 2:1 to about 2.5:1 may be used, including each intermittent value therebetween. Such films having been stretched in the machine-direction only after an extrusion processes may provide comparatively advantageous properties, such as yield, tensile strength, and flatness, that are similar to biaxially-oriented polypropylene films. In addition, some embodiments of such films may provide decreased gauge variation within the film.

In some embodiments of the present invention, a film may include additional film layers. For example, in some embodiments, films of the present invention may include a layer comprising high molecular weight high density polyethylene (HMW-HDPE) low density polyethylene, linear low density polyethylene, polypropylene, metalized biaxially-oriented polypropylene, any other polyolefins, other mineral-containing layers, combinations of any of the foregoing and/or other film layers. In addition, some embodiments of the present invention include films having at least a first film layer containing inorganic filler material and at least a second film layer have either no inorganic filler material or less inorganic filler material as compared with the first film layer. Multilayer films of the present invention may be prepared using coextrusion blown-film processes, extrusion lamination processes, or adhesive lamination processes, all of which are readily known within the art. In some embodiments, a high stalk extrusion process may be employed, as is common in the art with high molecular weight, high density polyethylene.

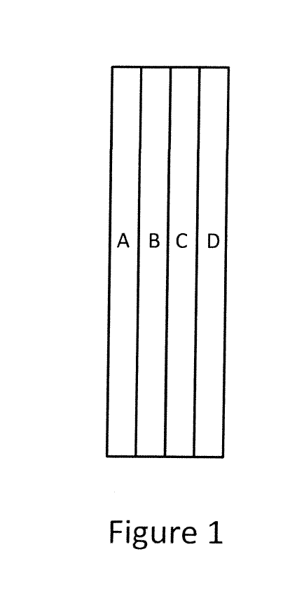

By way of example, and with reference to FIG. 1, one embodiment of a food packaging film product may be prepared as an adhesive lamination and include the following layers: (A) layer of metalized biaxially-oriented polypropylene, (B) optional layer of virgin low density polyethylene or linear low density polyethylene, (C) mineral-containing layer having calcium carbonate and high density polyethylene, and (C) optional printing layer as described below. In another embodiment, the present invention includes a film or film layer prepared by coextruding an inorganic filler material and high density polyethylene. By way of further illustration, a film of the present invention may include a polypropylene layer if temperature resistance and/or tear resistance are desired. In addition, some film products may include multiple mineral-containing film layers, such as two, three, four, or more such mineral-containing layers as disclosed herein.

The present invention further includes films having a single layer and films having multiple layers. The preparation of multi-layer films using multiple extruders is well known to a person having ordinary skill in the art. In some embodiments of the present invention, a coextrusion process may be used to prepare a film having a mineral-containing layer and a high density polyethylene skin layer. In some embodiments, one or more layer of a film product may have the same composition. Furthermore, in some embodiments, one or more or all layers of a multilayer film product may have a different composition. In one embodiment, at least one layer may contain an inorganic filler material, such as calcium carbonate in amount such as of at least about 50%. In some embodiments, a layer may contain at least about 10% to about 70% inorganic tiller material, including in embodiments prepared using a three-layer coextrusion die. In some embodiments, a skin layer of a film may contain from about 10% to about 30% inorganic tiller material and a center (or core) layer may contain from about 40% to about 80% inorganic filler material. During an extrusion process, the gauge of each layer of a resultant film may be adjusted such that the percentage of each layer to the total resulting film product may be varied.

In some embodiments of film products of the present invention, multiple identical film layers may be fused together to form a thicker single film or film layer, particularly, but not exclusively, to form a mineral-containing film layer having a desired thickness of about 1.5 mils or greater. For example, a desired film layer having a thickness of 2.0 mils and comprised of a blend of calcium carbonate and high density polyethylene may be prepared by fusing, with heat, two film layers of 1.0 mil thickness each with the same calcium carbonate and high density polyethylene blend. In one embodiment, such fused film layers may have a density of about 0.72 g/cc. As with other embodiments discussed herein, additional layers may also be added to such fused mineral-containing layers to form multilayer films.

Some embodiments of the present invention may include a film containing a mineral, such as calcium carbonate, having a rough or matted surface, which may result in a less desirable printing surface. Without intending to be bound by theory, such a rough or matted surface may result from voids in the film caused by the calcium carbonate particles. In some embodiments, a skin layer may be provided that may serve as a printing layer, wherein such skin layer has a decreased amount of mineral material or no mineral material. Such a printing layer may include any suitable polymer or polymer blend, including, without limitation, any of the compositions provided above for an additional layer and combinations thereof. Due to the absence or decreased amount of mineral material, such skin layer may provide improved printing in some embodiments.

In some embodiments of the present invention, one or more film layers may include a color component. For example, a printing skin layer may contain titanium oxide (TiO₂), which may provide a white color to the film. In other or alternative embodiments, TiO₂ may be included within any film layer during the extrusion process. In some embodiments, such coloring component may be provided at about 2% of the weight of the extrusion materials for that film layer. In some embodiments, TiO₂ may be provided in the range from about 2% to about 10% in any given layer, such as to provide a desired color and/or to provide a desired opacity of the film. In other embodiments, the coloring component may be present at up to about 2% of the weight of the extrusion materials for that film layer.

Films and film layers of the present invention may be prepared using any suitable process. In one particular embodiment of the invention, films are prepared using blown film extrusion processes. In addition, as indicated above, coextrusion processes may be used to prepare some multilayer film products of the present invention. In some embodiments, multi-layer films of the present invention may be prepared using extrusion lamination or adhesive lamination processes. Such processes are readily known within the art.

One of ordinary skill in the art will readily appreciate that films of the present invention are suitable for numerous uses. By ay of example and without limitation, film products of the present invention may be used with food products (such as butcher paper), freezer paper, packaging materials, bags, and other products.

The foregoing description of illustrative embodiments of the invention has been presented only for the purpose of illustration and description and is not intended to be exhaustive or to limit the invention to the precise forms disclosed. Numerous modifications, substitutions, alterations, and adaptations thereof will be apparent to those of ordinary skill in the art without departing in any way from the scope of the present invention. It will be further understood that each of the embodiments described above and the components thereof may also find utility in additional combinations or in isolation. As such, further modifications and equivalents of the invention herein disclosed may occur to persons skilled in the art using no more than routine experimentation, and all such modifications and equivalents are believed to be within the spirit and scope of the invention as described herein.

1. A film comprising at least one film layer that comprises, by:
at least about 40% inorganic filler material, and
at least about 10% high density polyethylene, including any high density polyethylene carrier in the inorganic filler material.

2. A blown film comprising at least a first film layer that comprises by weight:
at least about 40% calcium carbonate, and
at least about 10% high density polyethylene, including any high density polyethylene carrier in the calcium carbonate,
wherein the film has been stretched in the machine direction.

3. The blown film of claim 2 wherein the film has been stretched in the machine direction after an extrusion process at a draw-stretch ratio in the range of about 1:1 up to about 8:1.

4. The blown film of claim 2 wherein the film has been stretched in the machine direction after an extrusion process at a draw-stretch ratio in the range of about 1.1:1 up to about 2.5:1.

5. The blown film of claim 2 wherein the film has been stretched in the machine direction after an extrusion process at a draw-stretch ratio in the range of about 2:1 up to about 4:1.

6. The blown film of claim 2 wherein the film includes at least a second film layer without any inorganic filler material.

7. The blown film of claim 2 wherein the film includes at east a second film layer having less inorganic filler material than the first film layer.

8. The blown film of claim 2 wherein the film includes at least a second film layer comprising a polymeric material.

9. The blown film of claim 8 wherein the polymeric material is selected from the group consisting of high density polyethylene, high molecular weight high density polyethylene (HMW-HDPE), low density polyethylene, linear low density polyethylene, polypropylene, metalized biaxially-oriented polypropylene, and combinations thereof.

10. The blown film of claim 9 wherein the second film layer comprises less inorganic filler material than the first film layer.

11. The blown film of claim 9 wherein the second film layer comprises no inorganic filler material.

12. The blown film of claim 2 further comprising a second film layer fused to the first film layer, wherein the first film layer and the second film layer have a combined thickness that is greater than about 1.5 mils.

13. The blown film of claim 8 wherein the first film layer and the second film layer have the same compositions.

14. The blown film of claim 8 further comprising a coloring agent.

15. The blown film of claim 14 wherein the coloring agent is titanium oxide.

16. The blown film of claim 15 wherein the coloring agent is in the first film layer.

17. The blown film of claim 16 wherein the coloring agent constitutes about 2% by weight of the composition of the first film layer.

18. The blown film of claim 2 wherein the first film layer includes at least about 50% calcium carbonate.

19. The blown film of claim 2 wherein the first film layer is extruded from a blend comprising at least about 50% calcium carbonate by weight, at least about 30% high density polyethylene by weight including any high density polyethylene carrier in the calcium carbonate, and at least about 5% additional polyethylene having a melt index in the range of about 1.8 to 3.0 grams per ten minutes.

20. The blown film of claim 2 wherein the first film layer is extruded from a blend comprising by weight from about 40% to about 80% calcium carbonate, from about 10% to about 40% high density polyethylene including any high density polyethylene carrier in the calcium carbonate, and from about 5% to about 15% low density polyethylene.

21. The blown film of claim 2 wherein the first film layer is extruded from a blend comprising by weight about 70% calcium carbonate and about 30% high density polyethylene carrier, and wherein the calcium carbonate composition has a density of about 1.8 g/cm³, a melt index of about 0.03 g/dmin, an ash content of about 70% to about 74%, a moisture content of about 0.00% to about 0.05%, and a density of about 1.7 to about 1.9 g/cm³.

22. The blown film of claim 2 wherein the first film layer is extruded from a blend that consists essentially of from about 40% to about 80% calcium carbonate and from about 10% to about 40% high density polyethylene including any high density polyethylene carrier in the calcium carbonate, and the about 5% to about 15% low density polyethylene.

23. The blown film of claim 2 wherein the first film layer is extruded from a blend that consists essentially of from about 40% to about 80% calcium carbonate and from about 20% to about 60% high density polyethylene including any high density polyethylene carrier in the calcium carbonate.
